(19) United States
(12) Patent Application Publication
(10) Pub. No.: US 2016/0376983 A1
(43) Pub. Date: Dec. 29, 2016

(54) HIGHLY EFFICIENT TWO-STROKE INTERNAL COMBUSTION HYDRAULIC ENGINE WITH A TORQUING VANE DEVICE INCORPORATED.

(71) Applicant: RICARDO DANIEL ALVARADO ESCOTO, ROANOKE, TX (US)

(72) Inventor: RICARDO DANIEL ALVARADO ESCOTO, ROANOKE, TX (US)

(21) Appl. No.: 15/015,305

(22) Filed: Feb. 4, 2016

Related U.S. Application Data
(63) Continuation-in-part of application No. 14/746,897, filed on Jun. 23, 2015.

(51) Int. Cl. F02B 71/04

(52) U.S. Cl. CPC F02B 71/045

(57) ABSTRACT

The new embodiment of a highly efficient internal combustion hydraulic engine with a vane torquing device herein being provided, is designed to: a).—Maximize to the maximum extent possible the power and pressure produced by each combustion and convert it into mechanical use, and b).—To fit the engine snugly into all size trucks, pick-ups, heavy equipment, large and mid-size vehicles, snowmobiles, boats, buses, by placing the torquing device just below the cylinders. This new embodiment uses three electromagnetic actuators and one mechanical cam actuator to operate. It also has the following two additional features: first, an internal check valve located inside the block, which will make the engine more versatile, adaptable and supple to various road conditions. And second, a flexible longitudinal metal pin between the cam and the blind-type check-out-valve, to make the functioning of the engine more smooth and durable.

### CROSS-REFERENCE TO RELATED APPLICATIONS

The present application is a continuation-in-part of U.S. application Ser. No. 14/746,897, filed on Jun. 23, 2015. the entire content of which is hereby incorporated herein by reference.

### GLOSSARY OF TERMS

CHECK-VALVE: Are valves that allow the flow of a fluid in one direction only.

CAM: Is a metal device with a special form which while rotating move a pin back and forth.

CHAIN: Is a metal chain like in the bicycles which connect the motor shaft to the cam valve train and is properly adjusted to coordinate the cam revolutions.

FLEXIBLE PIN: Is a pin which is flexible longitudinally using a spring in one portion of their section.

INTERNAL-CHECK-VALVE: Is a check-valve inside and totally embedded in the block of the motor.

BLINDS-TYPE CHECK-OUT-VALVE: Is a check-valve which control the flow of a fluid in one direction by opening and closing metal blinds, similar to the one used in windows.

### BRIEF DESCRIPTION OF THE DIFFERENT VIEWS OF THE DRAWINGS

FIG. 25 Is a longitudinal view of the front of the third embodiment of the engine with the piston at TDC position.

FIG. 26 Is a lateral view of the metal pin 236, basically in the portion of the section where it becomes longitudinally flexible.

FIG. 27 Is a cross-cut sectional view of the portion of the pin in which it becomes longitudinally flexible.

### REFERENCE NUMERALS FOR THE DRAWINGS

Item.—234 They are cooling fins to dissipate the heat produced by the combustion in the cylinders 7.

Item.—235 Is a passage belonging to the internal check-valve 241 going from the low-pressure chamber 50 to the high-pressure chamber 13.

Item.—236 It is a simple longitudinally flexible metal pin driven by the cam 238, which produce the opening and closing of the blinds-type check-out valve mechanism 12.

Item.—237 It is a spring which make the pin 236 in the cam mechanism 242 to go up.

item.—238 It is the cam which push down the ping 236, making it to control the opening and closing of the exit windows blinds-type check-out valve mechanism 12.

Item.—239 Indicate a small spring located in the hinge of the gate 240, belonging to the internal check-valve mechanism 241.

Item.—240 Represent the gate who control the flow from the Low-pressure chamber 50 to high-pressure chamber 13.

Item.—241 Is the internal-check-valve mechanism built and totally embedded in the block 6 of the motor, between the low-pressure chamber 50 and the high pressure chamber 13.

Item.—242 This is the cam mechanism which control the check-out-valve 12 through the longitudinal flexible pin 236

Item.—243 It is a metal pin driven by the solenoid 9, which produce the opening and closing of the check-in-valve mechanism 11.

### DETAILED DESCRIPTION OF THE DRAWING

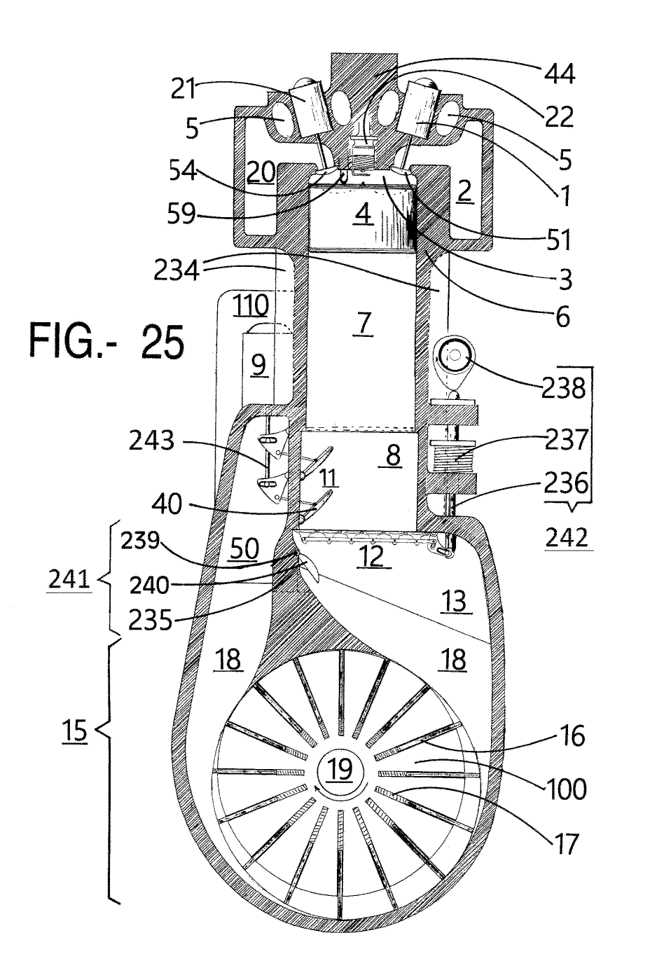

FIG. 25.

In this figure, the third embodiment is shown with the vane torquing device 15 underneath of the cylinders 7, the solenoid 9 for the check-in-valve mechanism 11 is located in one side of the motor, specifically beside the cylinders 7 and in the other side instead of the solenoid 10 a cam mechanisms 242 has been introduced.

Embedded in the block 6 of the motor, above and beside the drum 100 an internal-check-valve mechanism 241 has been included.

On the sides of the motor just beside the cylinders 7 the cooling passages 5 has been substituted by metal cooling fins 234.

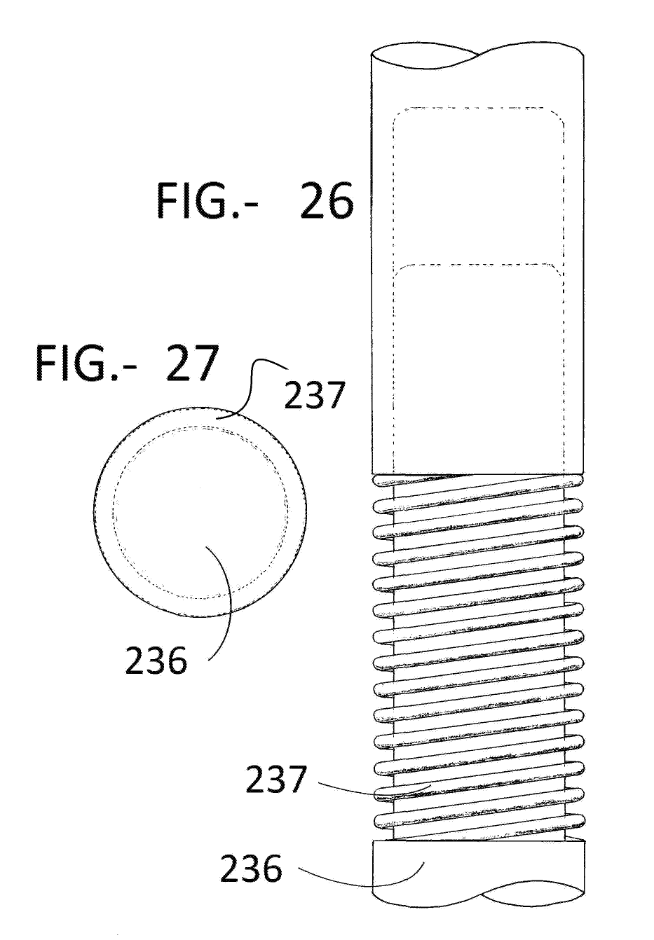

FIG. 26.

In this figure it is presented, a frontal section of the longitudinal flexible pin in the portion in which it becomes flexible and it show the strong spring 237 around.

FIG. 27.

This is just a cross-cut section of the longitudinal flexible metal pin 236 on the portion the spring is located.

### SUMMARY OF THE THIRD EMBODIMENT

The third embodiment represents better design specially for the use in trucks, buses and heavy equipment, the torquing device 15 has been located underneath the cylinder 7 which is a much better position to receive the hydraulic oil pressure generated by the piston 4.

The solenoid 9 is located on one side of the cylinder 7 and actuate with a mechanism similar to blinds. The force required for the actioning of the blinds or any other type of mechanism used for the check-in-valve 11 is very little, therefore a solenoid is well suitable.

The solenoid 10 in the original embodiment has been substituted by a cam mechanism 242, as the blinds-type check-out-valve 12 require a tremendous force to maintain itself closed when the high-pressure air and fuel or a premix air-fuel is introduced in the combustion chamber 3 before combustion. A cam mechanism as actuator is therefore more suitable.

A longitudinal flexible metal pin 236 being actuated by the cam 238 is introduced as vital an essential item, as the continuous explosions in the combustion chamber 3 can directly affect the blinds-type check-out valve 12 as well as the cam mechanism 242, the well adjusted flexibility of the pin 236 can alleviate and lessen the effects of the sudden pressure continuously generated.

Embedded In the block 6 and on top of the torquing drum 100, an internal-check-valve 241 has been introduced which will allow hydraulic oil to flow from the low-pressure chamber 50 to the high-pressure chamber 13, this type of internal-check-valve have a spring 239 in the hinge of the gate 240, to maintain the gate closed and to allow opening the gate only with some small calculated pressure, as it is important to note that some pressure is always required in the low-pressure chamber 50 as the piston 4 must move back to TCD position

This internal-check-valve 241 may not be needed in stationary generators or in industrial premises where engines run on a continuous load like compressors, mills or pumps.

This internal-check-valve 241 may be needed in trucks or vehicles going downhill while gear box engaged, or having inertia before going to a corner stop while gearbox engaged, or in any situation in which the shaft 19 can turn faster producing more pressure in the low-pressure chamber 50 than in the high-pressure chamber 13.

If the internal-check-valve 241 is not included then the vehicle may suffer several continuous small breaks, or sudden stop of the vehicle. In this situation the diaphragms 14 or 110 my not help.

This internal-check-valve 241 may be needed also in all type of heavy equipment which engages in rapid movements from one side to the other, creating a lot of vehicle inertia.

The cooling passages 5 beside the cylinders 7 have been eliminated and substitute by cooling fins 234, as this type of engine do not produce the huge pressure during combustion unlike the regular diesel or gasoline engines, therefore, the temperature on the side of the cylinders 7 is considerable much lower, however the cooling passages 5 on top of the combustion chamber 3 have been kept.

### OPERATIONS

The operation in this third embodiment is very similar to the first and original embodiment with the only difference that the blinds-type check-out-valve 12 is operated by a cam mechanisms 242 and that this cam 238 is connected to the engine shaft 19 by a chain which properly adjusted control its revolutions.

### ADVANTAGES

The main advantage of the third embodiment is in their design, which will be more suitable under the hood in trucks, heavy equipment and in any type of large and medium size vehicles.

Concerning the internal-check-out valve 241 and the longitudinal flexible metal pin 236, they are essentials and will contribute to make the engine ride more adaptable and smooth, and the motor more durable.

1. An internal-check-valve 241, embedded and properly located inside the motor block 6 to permit the hydraulic fluid going from said low-pressure chamber 50 to said high-pressure chamber 13, allowing the drum 100 turn freely.

2. A longitudinal flexible metal pin 236, connecting said actuator 242 to the said windows blinds-type check-out valve 12 permitting the mechanisms 242 and 12 or any other type of mechanism, to adapt to the sudden pressure produced by the continuous combustions.
